(19) United States
(12) Patent Application Publication
(10) Pub. No.: US 2020/0067723 A1
(43) Pub. Date: Feb. 27, 2020

(54) CONFERENCING DISTURBANCE DETECTION AND RESOLUTION

(71) Applicant: International Business Machines Corporation, Armonk, NY (US)

(72) Inventors: Kelley Anders, East New Market, MD (US); Jeremy R. Fox, Georgetown, TX (US); Jonathan Dunne, County Waterford (IE); Liam S. Harpur, Skerries (IE)

(73) Assignee: International Business Machines Corporation, Armonk, NY (US)

(21) Appl. No.: 16/109,706

(22) Filed: Aug. 22, 2018

(51) Int. Cl. H04L 12/18; H04L 12/26; H04L 12/24

(52) U.S. Cl. CPC H04L 12/1827; H04L 41/0668; H04L 43/50; H04L 43/065

(57) ABSTRACT

As a conference call is occurring, network data for the call is analyzed to identify an occurrence of a disturbance in the call. By injecting diagnostic traffic into the call, a first node is identified having a lowest performance score from a set of performance scores. By rerouting network traffic around the first node, the disturbance is remediated.

### TECHNICAL FIELD

The present invention relates generally to a method, system, and computer program product for network-based conferencing. More particularly, the present invention relates to a method, system, and computer program product for real-time network-based conferencing disturbance detection and resolution.

### BACKGROUND

Network-based conferencing, also known as web conferencing, includes components that predate the Internet, and has become increasingly popular as computer and device capabilities have improved.

Although network-based conferencing, as the name implies, relies on networks, for example TCP/IP connections, the term also includes auxiliary audio-only connections, allowing conferees to connect using any device capable of making or receiving a telephone call. Conferencing services connect multiple participants in real time, allowing text-based messages, the contents of participants' display screens, audio, and video to be shared simultaneously across geographically dispersed locations, supporting collaborations such as meetings, training events, and presentations without requiring participants to be present in person.

Each conference instance is called a “call”. Each call includes at least two participants, but may include many more, limited only by the capabilities of a conferencing service and the network infrastructure on which the conference service operates.

Many conferencing services designate one or a few participants as the leader, or host, of each call. Hosts often have extra administrative capabilities that ordinary call participants do not, such as the ability to initiate or end calls and to allow other participants to talk or present onscreen content. As well, conferencing services often include human or computer-implemented administrators or operators who can configure the service and make changes affecting many calls at once.

### SUMMARY

The illustrative embodiments provide a method, system, and computer program product. An embodiment includes a method that analyzes, as a conference call is occurring, network data for the call to identify an occurrence of a disturbance in the call. The embodiment identifies, by injecting diagnostic traffic into the call, a first node having a lowest performance score from a set of performance scores. The embodiment remediates, by rerouting network traffic around the first node, the disturbance.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for real-time network-based conferencing disturbance detection and resolution in accordance with an illustrative embodiment; and

FIG. 4 depicts a flowchart of an example process for real-time network-based conferencing disturbance detection and resolution in accordance with an illustrative embodiment.

### DETAILED DESCRIPTION

As larger-scale network-based conferencing becomes a staple of workplace collaboration, the incidence of technical difficulties on calls also potentially increases. Network or device difficulties may cause echoes, distortions, and other audio or video problems. Participants may be unable to speak or share their screens, or shared screens may freeze or update only partially. If problems are too severe, participants may be unable to connect to the call at all, or may be disconnected from the call without warning. Even if the problems only affect one person's presentation, everyone on the call—perhaps several hundred listeners—is affected. Most of the time, participants are unable to determine the cause of the difficulties themselves, so their only remedy is to disconnect and attempt to reconnect to the call, or abandon the call completely and reschedule for another time. Dealing with such difficulties costs participants both time and money. When technical difficulties arise, conferencing services need a way to detect such issues real-time, determine a resolution, alert a meeting administrator if necessary, and apply the resolution.

The illustrative embodiments recognize that the presently available tools or solutions do not address these needs or provide adequate solutions for these needs. The illustrative embodiments used to describe the invention generally address and solve the above-described problems and other problems related to real-time network-based conferencing disturbance detection and resolution.

An embodiment can be implemented as a software application. The application implementing an embodiment can be configured as a modification of a conferencing system, as a separate application that operates in conjunction with an existing conferencing system, a standalone application, or some combination thereof.

Particularly, some illustrative embodiments provide a method by which it can be determined that a disturbance during a call is occurring, and take steps to resolve the problem by remedying the disturbance.

An embodiment is configured to monitor a call when an administrator or host initiates the call, or at a later time during the call. The embodiment monitors both meeting activity, such as audio, video, and screen sharing, as well as the network on which participants on the call are communicating, to detect disturbances in the call. For example, an embodiment monitors the TCP/IP level of the network to determine whether packets are being lost or a change in the cadence of packet distribution across network is occurring. An embodiment also monitors sockets on the network, to determine which sockets are open and which are closed. An embodiment monitors audio, video, and screen sharing quality to detect if, for example, video is being pixilated, is not updating, or is updating slowly, or audio is being garbled, echoed, or there is buzzing or other background noise. These examples are not intended to be limiting; those of ordinary skill in the art will be able to conceive many other call disturbances, and the same are contemplated within the scope of the illustrative embodiments.

Once an embodiment detects a disturbance, the embodiment determines the circumstances of the disturbance, including the type of disturbance (such as audio, video, or screen sharing), when the disturbance occurred, which network location and layer were affected, and which user was speaking at the time. This determination also includes the network state—for example, socket states and where packets are moving more slowly or being lost, as well as which network nodes are connected to the call, the IP addresses these nodes are using, and the quality of the links to these nodes. These examples are also not intended to be limiting; those of ordinary skill in the art will be able to conceive other such disturbance-related data, and the same are contemplated within the scope of the illustrative embodiments.

An embodiment maps the call and groups call participants into proximate clusters based on the map. An embodiment maps the call using information describing how call participants have connected to the call, as well as other network and conferencing application information. Such information includes, but is not limited to, usernames and device names, TCP/IP socket layer information, packets, the IP addresses of the participants, the attributes associated with different nodes, and traffic data. For example, consider a call with five internal participants—all employed by the same company—and three external participants. The five internal participants have all connected to the call using devices with IP addresses that are also internal to the company, while two of the external participants are connected using external IP addresses. The third participant lacks a device with a microphone or speakers, so is participating in the audio portion of the call via telephone, but is watching screen content using the browser on his device. Each user using a similar connection type, or using a similar portion of the network, is likely to be similarly affected by a disturbance in the call. Hence for this example, the five internal participants could be clustered together, and the three external participants could be grouped into another cluster. For further refinement, the external participant using telephone for audio could be separated from the two who are only connected using their devices.

An embodiment also maps the call using the roles of the participants. For example, if the call host is making a presentation—indicated by all the other participants being muted, and the host sharing the contents of his device's screen—the host can be put into one cluster and all the passive participants into another. As another example, if the call is interactive—all the participants are able to speak—but only a few are actually participating, and the rest are just listening passively, the active participants can be put into one cluster and the passive participants into another.

Once users, or their equivalent call nodes, with similar attributes have been formed into clusters, an embodiment evaluates the performance of each cluster, and each node within each cluster, by injecting diagnostic traffic into the call and analyzing the speed and quality with which that traffic is distributed to the rest of the call. An embodiment analyzes traffic distribution both on a node-to-node basis within a cluster, and from one cluster to another. Based on the traffic analysis, an embodiment assigns awards to nodes in the call map with better than average performance, raising the scores for such nodes, and assigns penalties to nodes in the call map with poorer than average performance, lowering the scores for such nodes. Another embodiment assigns penalties to nodes in the call map when the transfer rate for those nodes falls below a defined threshold, such as a particular value of megabytes or gigabytes per second, lowering the scores for such nodes. In a further refinement, an embodiment assigns awards and penalties proportionally to network performance, where network performance is measured by traffic speed, traffic quality, or the combination of traffic speed and quality.

An embodiment determines the best performing nodes, based on the awards and penalties assigned to each node. For example, the nodes having the highest scores may be considered the optimally performing nodes. Other scoring schemes are also known to those of ordinary skill in the art and contemplated within the scope of the illustrative embodiments. Once the embodiment has identified the best performing nodes, the embodiment can compare the best performing nodes with the others to determine the worst performing nodes. The worst performing nodes are likely the source of any disturbance the call is experiencing, so once these nodes are identified an embodiment can identify one or more remedial actions.

An embodiment provides recommended remedial actions to an administrator for action. An embodiment may also take a remedial action automatically, without the involvement of a human administrator. Remedial actions attempt to compensate for or improve the call disturbance by rerouting network traffic around the worst performing nodes. Some examples of possible remedial actions for audio problems include muting all the participants, and then unmuting only the current speaker's, or the speaker's and the host's lines; and disconnecting one participant with an echoing audio connection and instructing that participant to reconnect to the conference, using the same or a different connection method. Video problems may be remediated, for example, by rerouting traffic to better-performing network nodes to avoid degraded performance, or by limiting video traffic by only showing video of the current speaker or the most active users. In addition, an embodiment alerts a meeting host of any remedial actions taken, via a sidebar message, pop-up window, or any other suitable alert mechanism compatible with a conferencing application.

Once a disturbance has been successfully remediated, an embodiment returns to monitoring the call for an additional disturbance. If an additional disturbance occurs, the embodiment repeats the steps described herein to process and remediate the new disturbance. A fresh performance analysis must be performed for each new disturbance, because packet routing, network conditions, a user's WIFI or cellular signal strength, or any other factor affecting call performance may have changed in the time between detected disturbances.

As well, an embodiment catalogs types of disturbances over time and analyzes trends, producing a prediction model that predicts the likelihood of types of disturbances, given a meeting having certain properties, as well as the likelihood of the effectiveness of particular remedial actions for particular types of disturbances. As a result, over time disturbances can be remedied more quickly, or even prevented from occurring.

The manner of real-time network-based conferencing disturbance detection and resolution described herein is unavailable in the presently available methods. A method of an embodiment described herein, when implemented to execute on a device or data processing system, comprises substantial advancement of the functionality of that device or data processing system in identifying portions of a call network contributing to such disturbances and acting to remove such portions, while preserving functionality for the rest of the call participants.

The illustrative embodiments are described with respect to certain types of contents, transmissions, disturbances, events, periods, forecasts, thresholds, validations, responses, rankings, adjustments, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

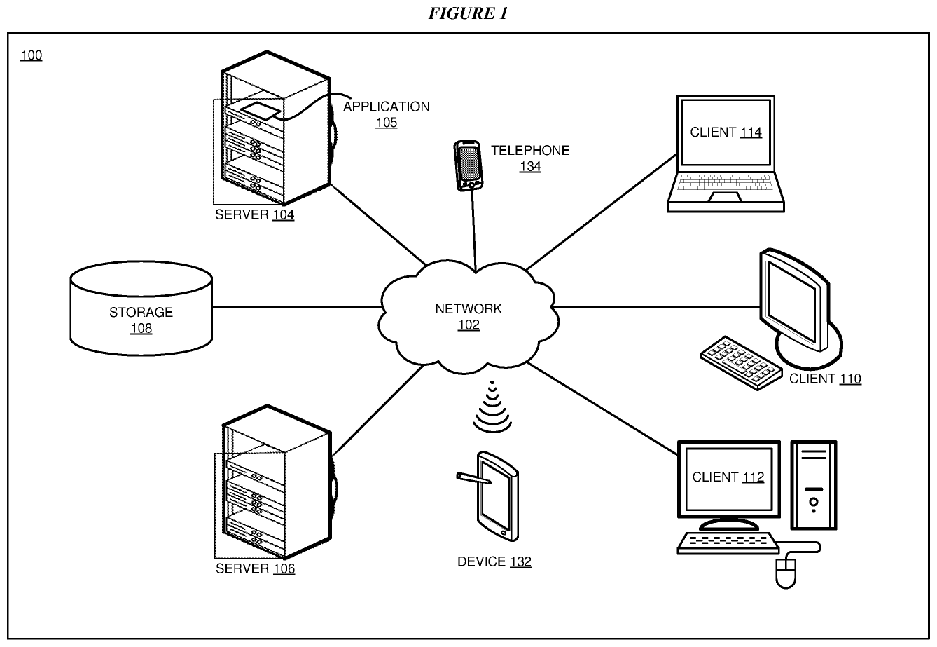

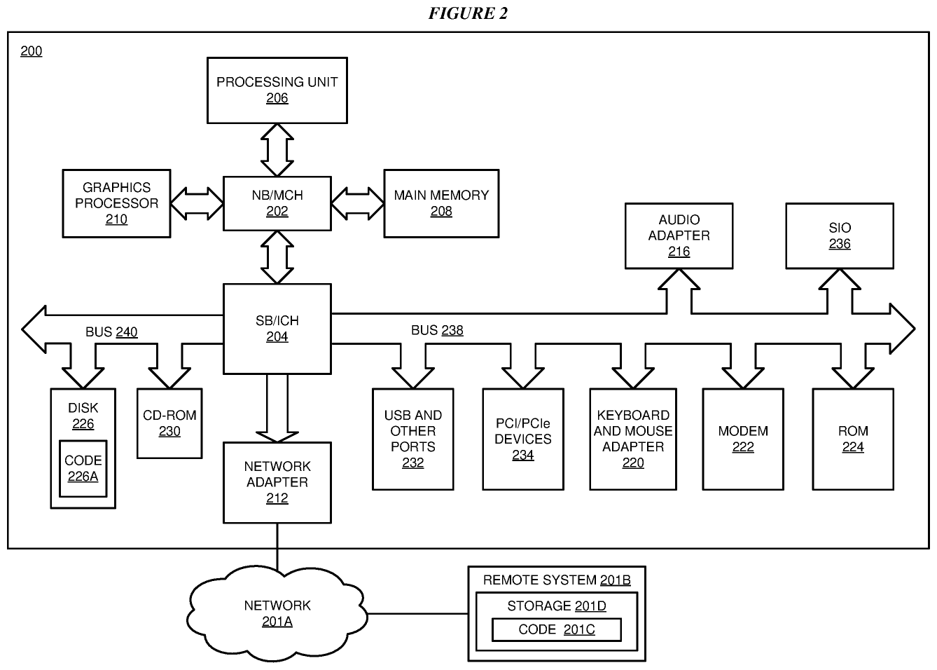

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. As an example, a user may participate in a call using any of clients 110, 112, and 114, and device 132. A user may also listen to or participate in the audio portion of a call using telephone 134, alone or in combination with using any of clients 110, 112, and 114, and device 132 for the non-audio portion of a call.

Telephone 134 may couple to network 102 using wired connections, wireless communication protocols, or other suitable data or telephony connectivity. Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

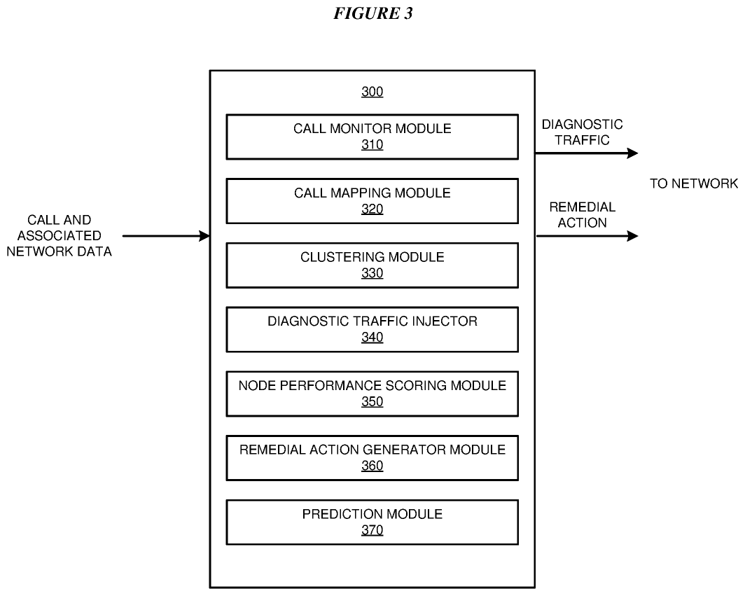

With reference to FIG. 3, this figure depicts a block diagram of an example configuration for real-time network-based conferencing disturbance detection and resolution in accordance with an illustrative embodiment. Application 300 is an example of application 105 in FIG. 1 and executes in server 104 in FIG. 1.

Call monitor module 310 monitors a call running on a network, for example network 102 in FIG. 1. Call monitor module 310 begins monitoring the call when an administrator or host initiates the call, or at a later time during the call. Call monitor module 310 monitors call data, including meeting activity, such as audio, video, and screen sharing, as well as activity on the network on which participants on the call are communicating, to detect disturbances in the call. Using this data, call monitor module 310 detects disturbances in the call such as lost or slow packets, video issues such as pixilation or slow or no updating, and audio that is being garbled or echoed.

Once call monitor module 310 detects a disturbance in a call, call mapping module 320 maps the call using information describing how call participants have connected to the call, as well as other network and conferencing application information such as TCP/IP socket layer information, packets, the IP addresses of the participants, the attributes associated with different nodes, and traffic data. Call mapping module 320 also maps the call using the roles of the participants.

Once call mapping module 320 has mapped the call, clustering module 330 groups call participants into proximate clusters based on the map. Diagnostic traffic injector 340 injects diagnostic traffic into the call. Node performance scoring module 350 analyzes the speed and quality with which the diagnostic traffic is distributed to the rest of the call, assigning higher scores nodes in the call map with better than average performance and assigning lower scores to nodes in the call map with poorer than average performance to determine the worst performing nodes in the call. Once the application identifies the worst performing nodes, remedial action generator module 360 generates remedial actions to remedy the call disturbance by rerouting network traffic around the worst performing nodes. As well, prediction module 370 catalogs types of disturbances over time and analyzes trends, producing a prediction model that predicts the likelihood of types of disturbances, given a meeting having certain properties, as well as the likelihood of the effectiveness of particular remedial actions for particular types of disturbances.

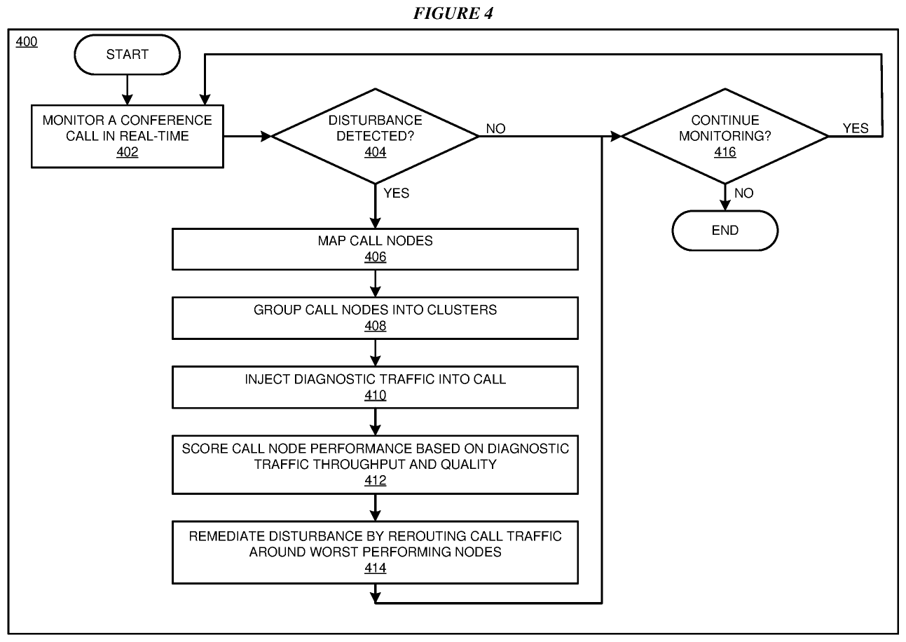

With reference to FIG. 4, this figure depicts a flowchart of an example process for real-time network-based conferencing disturbance detection and resolution in accordance with an illustrative embodiment. Process 400 can be implemented in application 300 in FIG. 3.

The application begins by monitoring a conference call in real-time (block 402). When a disturbance in the call is detected (“YES” path of block 404), the application maps call nodes representing call participants (block 406) and groups the call nodes into proximate clusters based on the map (block 408). In block 410, the application injects diagnostic traffic into the call, and in block 412 the application scores each call node's performance based on the throughput and quality of the diagnostic traffic through each call node. Next, in block 414, the application remediates the disturbance by rerouting call traffic around the worst performing call nodes. Once the disturbance has been remediated, or if no disturbance was detected in the first place (“NO” path of block 404), in block 416 the application determines whether or not to continue monitoring the call. If yes (“YES” path of block 416), the application returns to block 402 to continue monitoring the call. If not (“NO” path of block 416), the application ends.

Thus, a computer implemented method, system or apparatus, and computer program product are provided in the illustrative embodiments for real-time network-based conferencing disturbance detection and resolution and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
analyzing, as a conference call is occurring, network data for the call to identify an occurrence of a disturbance in the call;
identifying, by injecting diagnostic traffic into the call, a first node having a lowest performance score from a set of performance scores; and
remediating, by rerouting network traffic around the first node, the disturbance.

2. The method of claim 1, further comprising:
grouping, based on data representative of the disturbance, nodes of the call having similar characteristics into clusters.

3. The method of claim 2, wherein injecting diagnostic traffic into the call further comprises:
injecting diagnostic traffic into a cluster.

4. The method of claim 1, wherein identifying a first node having a lowest performance score from a set of performance scores further comprises:
computing a set of performance scores, wherein each performance score represents a diagnostic traffic processing performance of one node.

5. The method of claim 4, wherein each performance score is proportional to the diagnostic traffic processing performance of one node.

6. The method of claim 5, wherein each performance score comprises:
a throughput score representing a diagnostic traffic throughput of one node; and
a quality score representing a diagnostic traffic quality measure of one node.

7. A computer usable program product comprising one or more computer-readable storage devices, and program instructions stored on at least one of the one or more storage devices, the stored program instructions comprising:
program instructions to analyze, as a conference call is occurring, network data for the call to identify an occurrence of a disturbance in the call;
program instructions to identify, by injecting diagnostic traffic into the call, a first node having a lowest performance score from a set of performance scores; and
program instructions to remediate, by rerouting network traffic around the first node, the disturbance.

8. The computer usable program product of claim 7, further comprising:
program instructions to group, based on data representative of the disturbance, nodes of the call having similar characteristics into clusters.

9. The computer usable program product of claim 8, wherein injecting diagnostic traffic into the call further comprises:
program instructions to inject diagnostic traffic into a cluster.

10. The computer usable program product of claim 7, wherein program instructions to identify a first node having a lowest performance score from a set of performance scores further comprises:
program instructions to compute a set of performance scores, wherein each performance score represents a diagnostic traffic processing performance of one node.

11. The computer usable program product of claim 10, wherein each performance score is proportional to the diagnostic traffic processing performance of one node.

12. The computer usable program product of claim 11, wherein each performance score comprises:
a throughput score representing a diagnostic traffic throughput of one node; and
a quality score representing a diagnostic traffic quality measure of one node.

13. The computer usable program product of claim 7, wherein the computer usable code is stored in a computer readable storage device in a data processing system, and wherein the computer usable code is transferred over a network from a remote data processing system.

14. The computer usable program product of claim 7, wherein the computer usable code is stored in a computer readable storage device in a server data processing system, and wherein the computer usable code is downloaded over a network to a remote data processing system for use in a computer readable storage device associated with the remote data processing system.

15. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to analyze, as a conference call is occurring, network data for the call to identify an occurrence of a disturbance in the call;
program instructions to identify, by injecting diagnostic traffic into the call, a first node having a lowest performance score from a set of performance scores; and
program instructions to remediate, by rerouting network traffic around the first node, the disturbance.

16. The computer system of claim 15, further comprising:
program instructions to group, based on data representative of the disturbance, nodes of the call having similar characteristics into clusters.

17. The computer system of claim 16, wherein injecting diagnostic traffic into the call further comprises:
program instructions to inject diagnostic traffic into a cluster.

18. The computer system of claim 15, wherein program instructions to identify a first node having a lowest performance score from a set of performance scores further comprises:
program instructions to compute a set of performance scores, wherein each performance score represents a diagnostic traffic processing performance of one node.

19. The computer system of claim 18, wherein each performance score is proportional to the diagnostic traffic processing performance of one node.

20. The computer system of claim 19, wherein each performance score comprises:
a throughput score representing a diagnostic traffic throughput of one node; and
a quality score representing a diagnostic traffic quality measure of one node.
